(19) United States
(12) Patent Application Publication
(10) Pub. No.: US 2023/0359946 A1
(43) Pub. Date: Nov. 9, 2023

(54) SYSTEM AND METHOD FOR MANAGING FACILITY SPACE

(71) Applicant: Building Robotics, Inc., Oakland, CA (US)

(72) Inventor: Tanuj Mohan, Mountain View, CA (US)

(21) Appl. No.: 17/832,302

(22) Filed: Jun. 3, 2022

Related U.S. Application Data
(60) Provisional application No. 63/364,304, filed on May 6, 2022.

(51) Int. Cl. G06Q 10/02; H04L 41/0896

(52) U.S. Cl. CPC G06Q 10/02; H04L 41/0896; H04L 47/822

(57) ABSTRACT

There is disclosed a system, method, and medium for management of facility space. Occupancy data is received in which the occupancy data includes space allocation data by facility space categories. An average utilization over a first period of time for each facility space category is determined. At least one of an under utilization or an over utilization of the facility space over the first period of time is identified. A corrective action to shift space utilization of the facility space during a second period of time is generated.

### RELATED APPLICATION

This patent document claims priority under 35 U.S.C. § 119 and all other benefits from U.S. provisional application No. 63/364,304, titled “System and Method for Managing Facility Space,” filed May 6, 2022, the content of which is hereby incorporated by reference to the extent permitted by law.

### FIELD OF THE INVENTION

This application relates to the field of facility management systems and, more particularly, to systems and methods to facilitate efficient utilization and management of space for one or more facilities.

### BACKGROUND

Representations of space utilization of managed areas, such as an office space or big box retail store, are necessary but difficult to manage. Such representations take the form of a multitude of spreadsheets, maps, or specifications, and combining the representations is generally a manual process. In some cases, Spreadsheets may be used to filter or combine numerical data, and two dimensional graphs may be available to compare two different aspects of a given space. Even so, evaluating these conventional representations can be complex and difficult.

Conventional building automation systems may have sensors to detect occupancy of rooms of a two dimensional floor over time to generate a “heat map” of the rooms based on the occupancy data. A building owner or facility manager still needs to interpret such heat maps manually to determine what rooms may be combined or divided to optimize utilization of space. Moreover, the heat maps do not present the combined utilization of similar and different types of rooms in a useful way to provide the building owner or facility manager with options for combining spaces of one or more buildings.

### SUMMARY

In accordance with one embodiment of the disclosure, there is provided a space management approach of a building management systems for efficient utilization of space. The approach includes a visual representation of space providing a sense of what is happening in the space currently, in the past, and in the future. The visual representation also allow an operator or manager to design and configure optimal use of the space. Accordingly, manual review of spreadsheets or other types of data by the operator or manager is minimized.

One aspect is a system for management of facility space comprising an input component and a processor. The input component receives occupancy data including space allocation data by facility space categories. The processor determines an average utilization over a first period of time for each facility space category, identifies at least one of an under utilization or an over utilization of the facility space over the first period of time, and generates a corrective action to shift space utilization of the facility space during a second period of time.

Another aspect is method for managing of facility space. Occupancy data is received by a management device in which the occupancy data includes space allocation data by facility space categories. An average utilization over a first period of time for each facility space category is determined by the management device. At least one of an under utilization or an over utilization of the facility space over the first period of time is identified by the management device. A corrective action to shift space utilization of the facility space during a second period of time is generated by the management device.

Yet another aspect is a non-transitory computer readable medium including executable instructions which, when executed, cause at least one processor to manage utilization of facility space. Occupancy data is received in which the occupancy data includes space allocation data by facility space categories. An average utilization over a first period of time for each facility space category is determined. At least one of an under utilization or an over utilization of the facility space over the first period of time is identified. A corrective action to shift space utilization of the facility space during a second period of time is generated.

The above described features and advantages, as well as others, will become more readily apparent to those of ordinary skill in the art by reference to the following detailed description and accompanying drawings. While it would be desirable to provide one or more of these or other advantageous features, the teachings disclosed herein extend to those embodiments which fall within the scope of the appended claims, regardless of whether they accomplish one or more of the above-mentioned advantages.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects.

FIG. 1 is an illustration of a system for efficient management of space for one or more facilities in an example implementation that is operable to employ techniques described herein.

FIG. 2 represents, in an example implementation, a possible allocation of space for a designated area of one or more facilities of FIG. 1.

FIG. 3 is a side planar view of a portion of a facility in an example implementation illustrating possible sensor locations in a facility of FIG. 1.

FIG. 4 is a graphical view of a space allocation representation in an example implementation that is operable to employ techniques described herein.

FIG. 5 is a graphical view of a representation of space allocation in an example implementation based on geography.

FIG. 6 is a block diagram, in an example implementation, of various components of the management device of FIG. 1.

FIG. 7 is a flow diagram, in an example implementation, of an operation of the management device of FIG. 1.

### DETAILED DESCRIPTION

Various technologies that pertain to systems and methods that manage efficient utilization of space for one or more facilities will now be described with reference to the drawings, where like reference numerals represent like elements throughout. The drawings discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged apparatus. It is to be understood that functionality that is described as being carried out by certain system elements may be performed by multiple elements. Similarly, for instance, an element may be configured to perform functionality that is described as being carried out by multiple elements. The numerous innovative teachings of the present application will be described with reference to exemplary non-limiting embodiments.

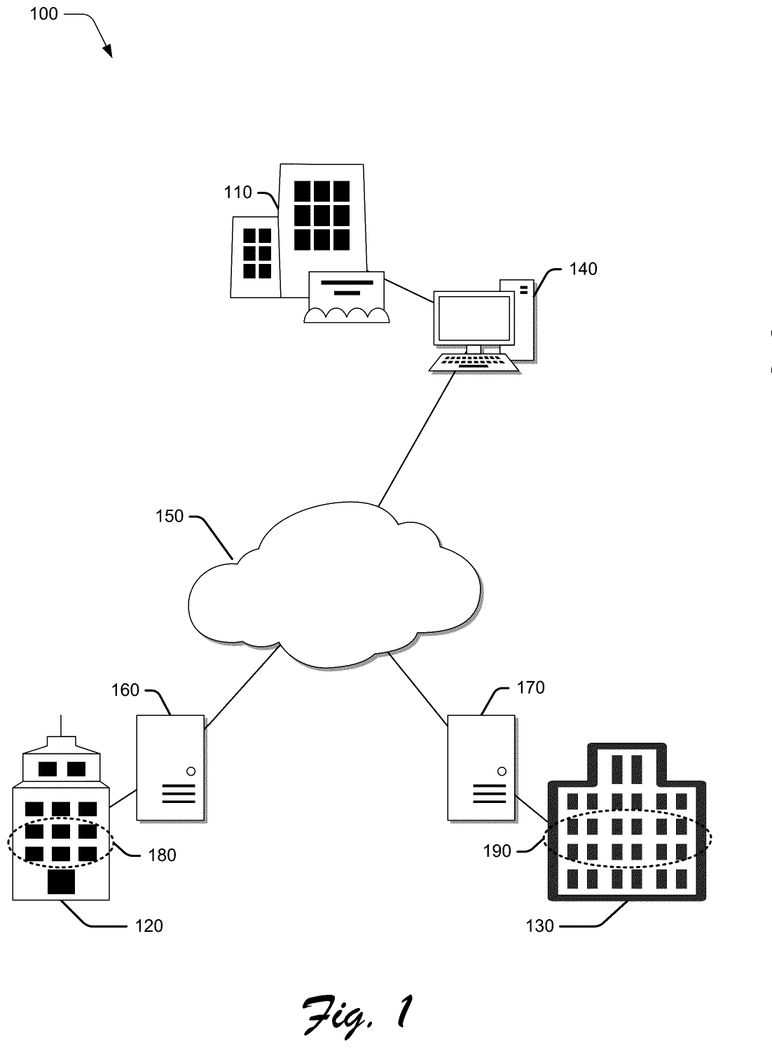

Referring to FIG. 1, there is shown a high-level representation of a system 100 for efficient management of space for one or more facilities 110, 120, 130. The facility space management system 100 includes a management device 140 located on-site at a facility 110 and/or remote from one or more facilities 120, 130. The management device 140 may communicate with presence sensors, control devices, or both presence sensing and control devices of an on-site facility 110 and/or remote facility 120, 130 via a network connection 150. Examples of the network connection 150 include, but are not limited to, a Cloud network or the Internet. For some embodiments, each remote facility 120, 130 may include a facility gateway 160, 170 to manage communication of data from the presence sensors of the corresponding facility to the management device 140 and/or control signals from the management device to the control devices of the facility. The presence sensors and the control devices may be located throughout the corresponding facility or at specific locations 180, 190, such as select floors of the facility. Thus, the management system 140 may manage space for part or all of each facility 110, 120, 130.

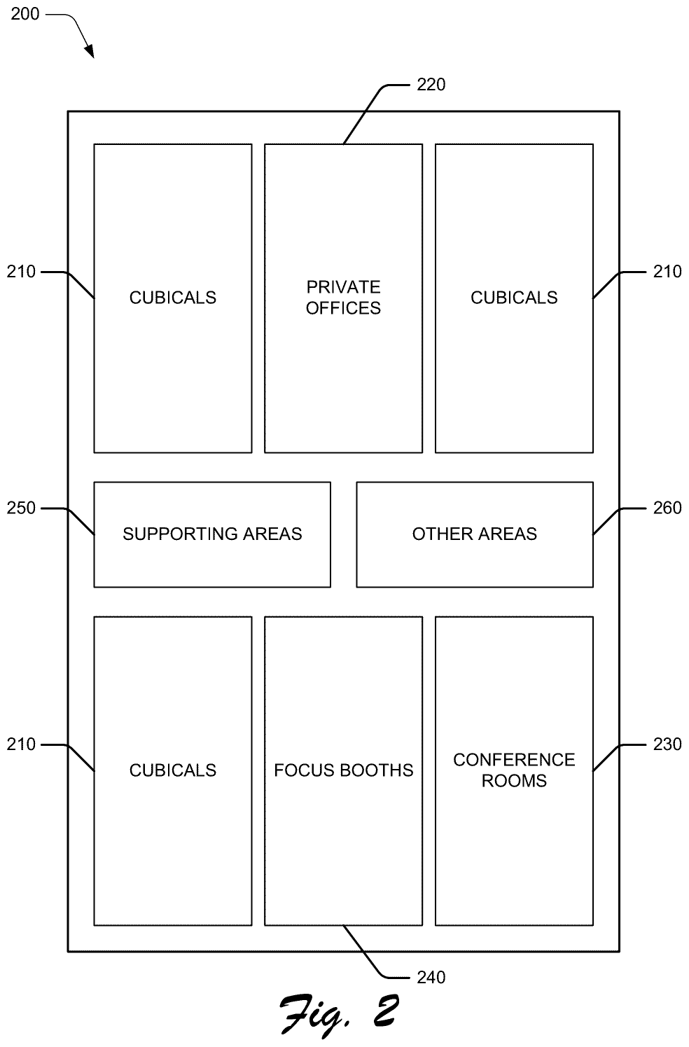

Referring to FIG. 2, there is shown an example representation of a possible allocation of space for a designated area 200 (e.g., floor) of a facility, such as facilities 110, 120, 130. The representation illustrates, by example, the allocation of workstation spaces, shared spaces, and other spaces for the designated area 200 managed by the facility space management system 100. Examples of workstation spaces include, but are not limited to, cubical areas 210 and private office areas 220. Cubical areas 210 are partially enclosed office workspaces separated from other spaces or areas by partitions. Private office areas 220 are fully or substantially enclosed office workspaces separated from other spaces or areas by walls.

Examples of shared spaces includes, but are not limited to, conference rooms 230 and focus booths 240. Because these spaces are shared, conference rooms 230 and focus booths 240 provide privacy to their occupants in order to communicate with others within the space or between remote locations. For example, the shared spaces may accommodate a single person for remote communications or multiple people for face-to-face and/or remote communications. Thus, similar to private office areas 220, conference rooms 230 and focus booths are fully or substantially enclosed work areas separated from other spaces or areas by walls. For conference rooms 230, a large conference room may accommodate a large group of occupants and a small conference room may accommodate a smaller group of occupants. A focus room 240 is typically smaller than a small conference room and, thus, accommodates one or two people. Examples of focus rooms 240 include, but are not limited to, phone rooms or private workspaces.

Examples of other spaces include, but are not limited to, supporting areas 250 such as administrative offices, maintenance rooms, storage rooms, and transport spaces, as well as other areas 260. Transport spaces, in particular, may be utilized for elevators, stairways, and other mechanisms for moving people and objects to and from the designated area 200. Other areas 260 include, but are not limited to, common areas shared by the occupants and visitors of the designated area 200, such as reception areas, open meeting/display areas, dining areas, break rooms, libraries, file rooms, shared equipment rooms, and the like.

It is important to note that workstation spaces, shared spaces, and supporting spaces of the designated area 200 may allocated as fixed structures of the designated area or as modular structures located in an open office of the designated area. A fixed structure is any type of physical property that is permanently attached or fixed to the physical structure of a facility. A modular structure is any type of physical property that is movably positioned within the physical structure of a facility. Portions of a modular structure may be fixed to each other, but the entirety of the modular structure is not fixed, or minimally fixed, to the physical structure of the facility. Examples of minimally fixed portions include, but are limited to, tethered or hanging supports as well as fixed supports for mechanically rotatable or shiftable portions of a modular structure. Although fixed structures may be accommodated by the facility space management system 100, the system 100 is more suited for managing modular structures of one or more designated areas.

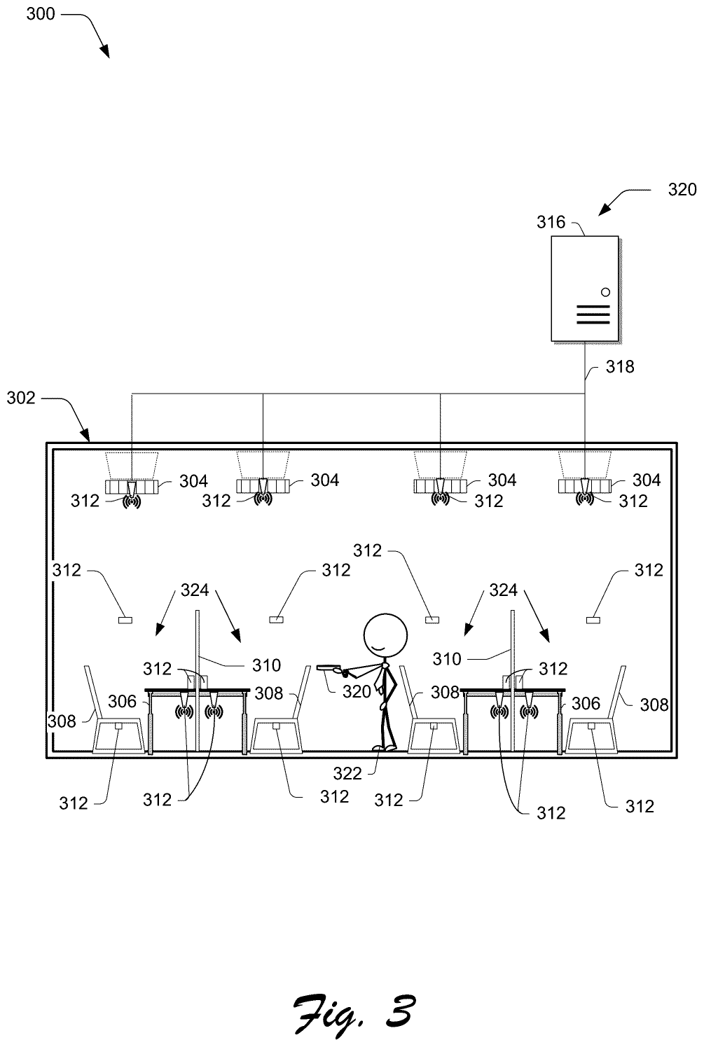

Referring to FIG. 3, there is shown a facility 300, representing a single facility or group of facilities, in an example implementation that is operable to employ techniques described herein. The facility 300 includes one or more predetermined areas 302 managed by facility space management system 100. Each predetermined area 302 of the facility 300 includes fixed objects such as light fixtures 304 as well as non-fixed objects such as tables 306, chairs 308, and partitions 310.

Each facility 300 may include presence sensors 312 to determine occupancy of workstation spaces, shared spaces, and other spaces for the designated area 200 managed by the facility space management system 100. For example, each presence sensor 312 may be located in the designated area 200 for detecting, analyzing, and/or transmitting occupancy data proximal to the sensor. It is to be understood that the sensors shown in FIG. 3 are representations that are not to scale and are not restricted to the positions shown. For example, any or all of the sensors may be positioned near a ceiling, wall, floor, partition, fixed object, non-fixed object (such as furniture), etc., as needed for desired for accurate or convenient detection of the occupancy data.

In addition to one or more kinds of sensors 312, 314, the system 100 includes an upstream device 316 communicating with the sensors. The upstream device 316 represents one or more computing devices that may be located at the facility, remote from the facility, or both where some computing devices are located at the facility whereas other computing devices are located remotely. The upstream device 316 may communicate with one or more groups of sensors 312, 314 via a wired or wireless link 318. For some embodiments, the management device 140 may also communicate with one or more mobile devices 136 located within the predetermined areas Examples of upstream devices 316 include, but are not limited to, management devices 140 and facility gateways 160, 170. The mobile devices 320 may be transported or otherwise supported by a user 322, or the mobile device may be self-propelled.

For some embodiments, multiple workstations 324 may be located within the predetermined area 302. A workstation 324 may be a cubical, office, conference room, focus room, or other designated area for utilization by a single person or multiple people. For example, a workstation 324 may be a desk separated from one or more other desks by a physical or virtual partition 116. An example of a virtual partition is a predetermined distance from a neighboring workstation. As another example, a workstation 140 may be a conference room, focus, room, or meeting area where one or more people may congregate. Also, one or more sensors may be positioned above an open area, such as a meeting corner, and report occupancy data.

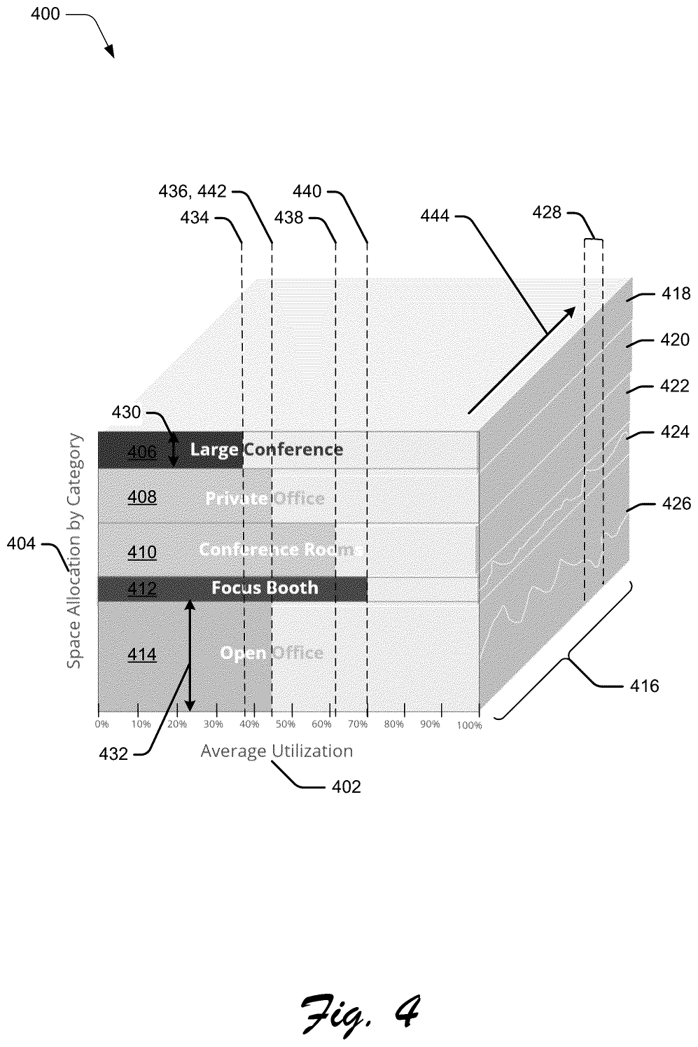

Referring to FIG. 4, there is shown is a graphical view of a space allocation representation 400 in an example implementation that is operable to employ techniques described herein. The space allocation may be represented in two or more dimensions, such as the three dimensional representation of FIG. 4. For the space allocation representation 400, a first dimension 402 may represent an average utilization of space allocation for one or more facilities over a first period of time, as illustrated as the x-axis. Also, a second dimension 404 may represent a space allocation by category of multiple facility space categories 406-414 for one or more facilities over the first period of time, as illustrated as the y-axis. For other embodiments, a third dimension 416 may represent a time period 418-426 corresponding to each category of space allocation. Each time period may include one or more sub-time periods 428 distinguishing under utilization or over utilization of a particular space or space type within the time period of the corresponding category.

Each layer of the space allocation representation 400 corresponds to a particular facility space category 406-414. For example, the space allocation representation 400 may include facility space categories 414, 406, 410 for an open office area 414 and a conference room area 406, 410. As another example, the space allocation representation may include facility space categories for one or more conference room areas 406, 410, one or more private office areas 408, one or more focus booth areas 412, and/or one or more open office areas 414. Examples of space types or categories include, but are not limited to, open office areas, private office areas, conference room areas, focus booth areas, common room areas, sectioned/partitioned areas, supporting areas, passageways, and other areas. For some embodiments, each facility space category may include multiple sub-categories, such as the conference room category being subdivided into a large conference category 406 and a non-large conference category 410.

Each particular facility space category 406-414 may be presented visually by the management device to represent the size of the particular facility space type or category relative to the other facility space categories or the designated area for the facility space categories. With the visual, the user will get a sense for how the space is divided. For example, each facility space category 406-414 shown by the space allocation representation 400 of FIG. 4 includes a size depiction 430, 432, such as a row height, representing the relative size of the particular facility space type. A shown by example, the open office area 414 has a size depiction 432 that is greater than a size depiction 430 for the large conference area 406 as well as the other facility space categories for the designated area.

Each particular facility space category 406-414 may also be presented visually by the management device to represent the under or over utilization of the particular facility space type or category. In particular, the utilization depictions 434-440 indicate the average utilization of each facility space category 406-414 as represented by the first dimension 402. To illustrate these visual presentations by example in FIG. 4, a first utilization 434 of the large conference category 406 is about 38%, a second utilization 436 of the private office category is about 45%, a third utilization 438 of the non-large conference room category 410 is about 62%, a fourth utilization 440 of the focus room category 412 is about 70%, and a fifth utilization 442 of the open office category 414 is about 45% over a first period of time.

For conventional techniques, space utilization heat maps may fail to identify spikes in occupancy data with respect to a time of day or a particular day of the week. Such spikes may influence how a building owner or facility manager may combine similar types of rooms or convert different types of rooms to handle the hidden occupancy spikes in time. The space allocation representation 400 aids a system or method of a building owner or facility manager to view, analyze, and process building occupancy data to optimize space utilization within one or more facilities.

Space utilization is measured in terms of occupancy over a period of time. Space occupancy may be further evaluated in terms of geography, volume, and/or type. Facilities may also have differing sizes, and occupancy may differ based on the size. In each case, occupancy of each space may change over time, throughout a given day or over a much longer period of time. In addition, space types may have different occupancy levels based on the needs of its occupants. Space may also be owned or occupied by different entities, such as engineering, sales, supply chain, share services, administration/management, and the like. There are many dimensions on how one may view physical space depending on vertical, i.e., different ways of slicing and analyzing the information.

Still referring to FIG. 4, the space allocation representation of the facility space management system 100 may further include one or more additional dimensions 416 may represent a time period 418-426 corresponding to each category 406-414 of space allocation. For some embodiments, each time period 418-426 may include one or more sub-time periods 428 distinguishing under utilization or over utilization of a particular space or space type within the time period of the corresponding category. The first and second dimensions 402, 404 shown in the forefront represents a one-period (e.g., “slice of that day” in the case of a one-day period) while time is on the axis going back in time 444. For some embodiments, the third dimension 416 may represent time going forward instead of, or in addition to, time going backward. Everyday, the user may have a sliced view and can make multiple slices to see how things change over time. The graphic may be browsed in a time dimension. For example, Monday may look fine but, over time, there may be a spike on Friday so the user may click on Friday to drill down. As such, the user may be able to determine which days to analyze further. Large conference rooms may used on Mondays, so Mondays may be a bit issue. Other conference rooms may become full on Wednesdays.

As a result of evaluating the occupancy of these conference rooms, the system or more particularly the management device of the system may identify under and/or over utilization of the facility space over the first period of time. The system or management device may then generate a corrective action to shift space utilization of the facility space during a second period of time, the second period of time being different from the first period of time. By adjusting room utilization in this manner, areas, floors, and/or facilities may be combined or separated for more efficient use of space. In addition, for some embodiments, the visual representation may also provide a way of providing information to the building owner or facility manager with space in terms of physical dimensions and time with one view.

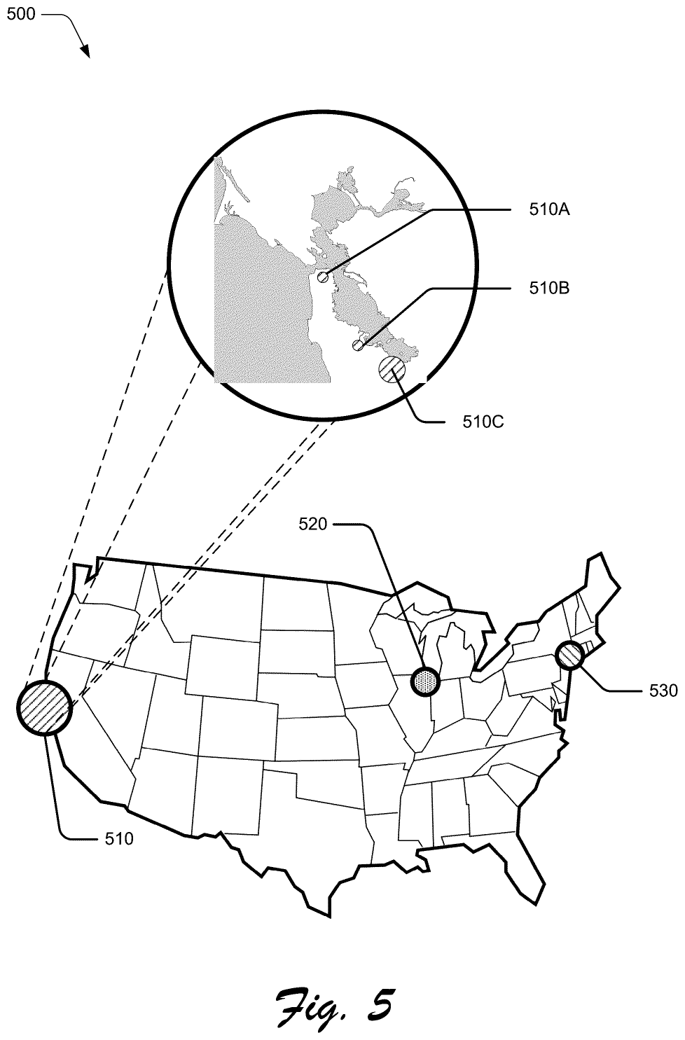

FIG. 5 is a graphical view of a representation 500 of space allocation in an example implementation based on geography. In addition to occupancy over time, space utilization may be measured in terms of geography. Facilities may be located in different locations, some being proximal to each other whereas others are quite distal, in which occupancy may differ based on location. Facilities may also have differing sizes, and occupancy may differ based on the size.

The visual representation 500 in FIG. 5 depicts the regional sizes 510 of the space. For example, a national map may show three locations for a particular group or related areas, i.e., areas associated with a single owner or facility manager. The regional size 510 of a particular location 510 is present to visually represent utilization relative to other locations 520, 530. For example, as illustrated in FIG. 5, a facility or group of facilities at first location 510 may be larger in terms of physical area, physical volume, volume of people, or utilization that a second or third location 520, 530.

The visual representation 500 may also distinguish facilities, or portions thereof, that may be consolidated from facilities, or portions thereof, that may not be consolidated. For example, the distinction between facilities that may be consolidated from those that may not be consolidated may be based on proximity of facilities to each other. As another example, the distinction between facilities that may be consolidated from those that may not be consolidated may be based on the determined distance or time associated with commute distances or times for facility occupants and visitors, such as employees, suppliers, or clients. The decision to combine or separate human or other resources may be based on the average utilization and capacity of the various facilities. Accordingly, some facilities 510A, 510B may be consolidated with one or more other facilities 510C in order to make more efficient use of space. Visualization provides insights, such as analyzing details of under and over utilization. The visual representation provides a feature of space planning to manage space in terms of reconfiguration in time, type, department, etc. In addition, the data and analyses may be output to a report if desired.

It is to be noted that certain areas of a facility may be flagged due to their restrictive or flexible characteristics, such as physical or business requirements. For example, lab or engineering environments may be dependent on some fixed building systems (such as requirements due to electrical, fire safety, radio frequency features), and HVAC systems may allow for limited mobility. Regarding business requirements, a contractual provision such as a building lease condition may restrict configurations or modifications to windows, rooms, walls, etc. Further, as noted above, the third dimension 416 shown in FIG. 4 may represent time in the future instead of, or in addition, to time in the past. For example, the time may indicate when a lease may expire, so a corrective action to shift space utilization of the facility space during a future period of time may be generated based on conditions of the lease.

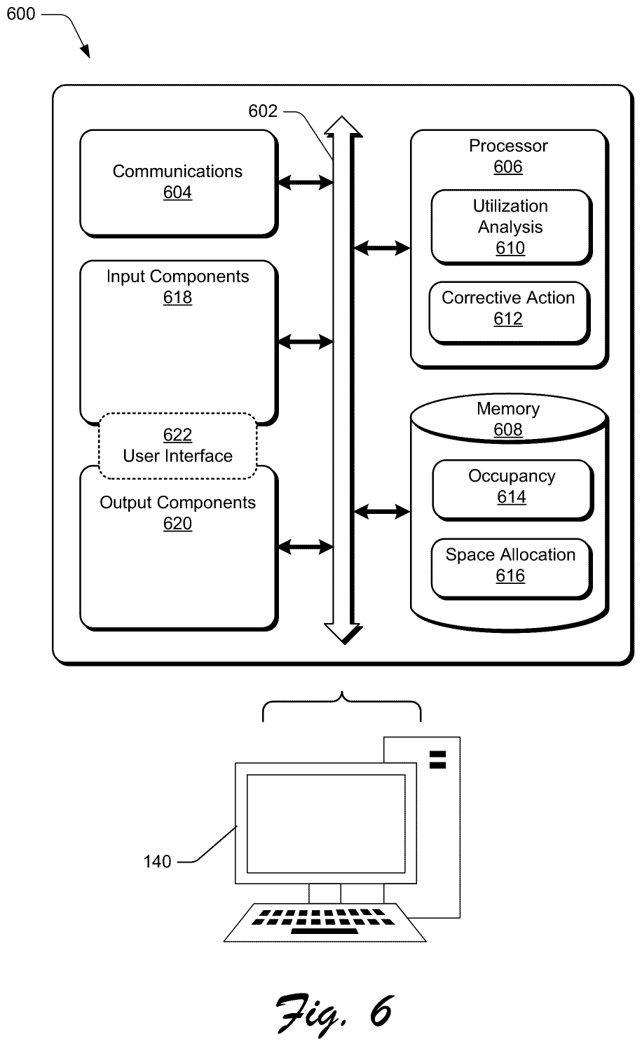

FIG. 6 represents example device components 600 of the management device 140. The device components 600 comprise a communication bus 602 for interconnecting other device components directly or indirectly. The other device components include one or more communication components 604 communicating with other entities via a wired or wireless network, one or more processors 606, and one or more memory components 608. The communication component 604 communicates (i.e., receives and/or transmits) data associated with one or more devices of the system 100, such as a mobile device or an external workstation. The communication component 604 may utilize wired or wireless technology for communication.

The processor or processors 606 may execute code and process data received from other components of the device components 600, such as information received at the communication component 604 or stored at the memory component 608. The code associated with the management device 140 and stored by the memory component 608 may include, but is not limited to, operating systems, applications, modules, drivers, and the like. An operating system includes executable code that controls basic functions, such as interactions among the various components of the device components 600, communication with external devices via the communication component 604, and storage and retrieval of code and data to and from the memory component 608.

Each application includes executable code to provide specific functionality for the processor 606 and/or remaining components of the management device 140. Examples of applications executable by the processor 606 include, but are not limited to, a utilization analysis module 610 and a corrective action module 612. The utilization analysis module 610 determines an average utilization over a first period of time for each facility space category and identifies at least one of an under utilization or an over utilization of the facility space over the first period of time. The corrective action module 612 generates a corrective action to shift space utilization of the facility space during a second period of time.

Data stored at the memory component 608 is information that may be referenced and/or manipulated by an operating system or application for performing functions of the management device 140. Examples of data associated with the management device 140 and stored by the memory component 608 may include, but are not limited to, occupancy data 614 and space allocation data 616. The occupancy data 614 includes space allocation by facility space categories over a first period of time. The space allocation data 616 includes space allocation for facility space categories during a second period of time as determined by the corrective action module 612.

The device components 600 may include one or more input components 618 and one or more output components 620. The input components 618 and output components 620 of the device components 600 may include one or more visual, audio, mechanical, and/or other components. One input component of the input components 618 may receive occupancy data including space allocation by facility space categories. One output component of the output components 620 may cause reallocation of the facility space at a remote device based on the corrective action. For some embodiments, the input and output components 618, 620 may include a user interface 622 for interaction with a user of the device. The user interface 622 may include a combination of hardware and software to provide a user with a desired user experience.

It is to be understood that FIG. 6 is provided for illustrative purposes only to represent examples of the management device 140 and is not intended to be a complete diagram of the various components that may be utilized by the system 100. Therefore, the management device 140 may include various other components not shown in FIG. 6, may include a combination of two or more components, or a division of a particular component into two or more separate components, and still be within the scope of the present invention.

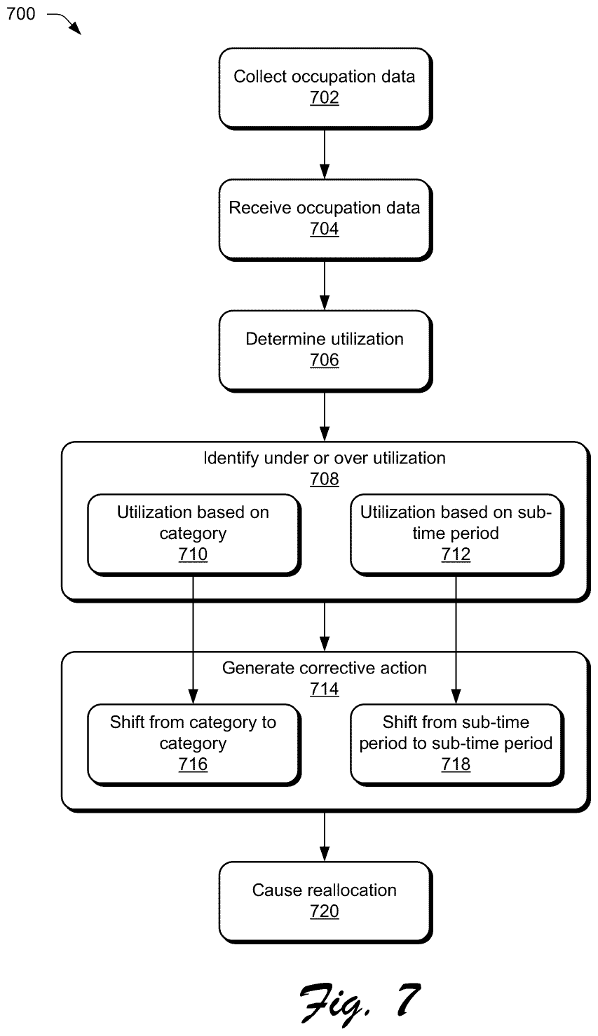

FIG. 7 is a flow diagram, in an example implementation, of an operation 700 of the management device 140 as well as one or more other devices of the system 100. Occupancy data of various areas of the facility space is collected 702 over a first period of time, and the management device 140 receives 704 the occupancy data. For example, the occupancy data may be collected from presence sensors located in the facility space. The occupancy data includes space allocation by facility space categories. The facility space categories include one or more of an open office area, a private office area, a conference area, or a focus booth area.

In response to receiving 704 the occupancy data, the management device 140 determines 706 an average utilization over the first period of time for each facility space category. In response to determining 706 the average utilization, the management device 140 identifies 708 one or more under utilizations of the facility space over the first period of time, one or more over utilizations of the facility space over the first period of time, or both. For some embodiments, the management devices 140 identifies 710 the under utilization or the over utilization of a particular facility space category over the first period of time. For some embodiments, the management device 140 identifies 712 the under utilization or the over utilization of a particular sub-time period over the first period of time.

In response to identifying 708 one or more under or over utilizations of the facility space, the management device 140 generates 714 a corrective action to shift space utilization of the facility space during a second period of time. For some embodiments, where utilization of the particular facility space category is identified 710, the management device 140 generates 716 the corrective action to shift space utilization of the particular facility space from one facility space category to another facility space category during the second period of time. For some embodiments, where utilization of the particular sub-time period is identified 712, the management device 140 generates 718 the corrective action to shift space utilization of the facility space from one sub-time period to another sub-time period during the second period of time.

For some embodiments, the corrective action may include communicating availability of the facility space during the second period of time, modifying access to the facility space during the second period of time, or a combination of communicating availability and modifying access. For example, as a result of evaluating the occupancy of these conference rooms, the system 100 may review meeting calendars of facility occupants or conference rooms and send messages to future meeting participants to reschedule their meetings. Meeting participants may be asked to reschedule one or more meetings to a day different from an over utilized day and/or time, to an under utilized day and/or time, or both. As another example, the system 100 may review meeting calendars of facility occupants or conference rooms and modify access to certain conference rooms. Portals of over utilized rooms may be locked and portals of under utilized rooms may be unlocked. Walls or partitions of under utilized rooms may be shifted so that they may have space or capacity more similar to over utilized rooms. By adjusting room utilization in this manner, buildings or floors may be combined for more efficient use of space.

In response to generating the corrective action 714, the management device 140 may cause 720 reallocation of the facility space at a remote device based on the corrective action.

Those skilled in the art will recognize that, for simplicity and clarity, the full structure and operation of all data processing systems suitable for use with the present disclosure are not being depicted or described herein. Also, none of the various features or processes described herein should be considered essential to any or all embodiments, except as described herein. Various features may be omitted or duplicated in various embodiments. Various processes described may be omitted, repeated, performed sequentially, concurrently, or in a different order. Various features and processes described herein can be combined in still other embodiments as may be described in the claims.

It is important to note that while the disclosure includes a description in the context of a fully functional system, those skilled in the art will appreciate that at least portions of the mechanism of the present disclosure are capable of being distributed in the form of instructions contained within a machine-usable, computer-usable, or computer-readable medium in any of a variety of forms, and that the present disclosure applies equally regardless of the particular type of instruction or signal bearing medium or storage medium utilized to actually carry out the distribution. Examples of machine usable/readable or computer usable/readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs).

Although an example embodiment of the present disclosure has been described in detail, those skilled in the art will understand that various changes, substitutions, variations, and improvements disclosed herein may be made without departing from the spirit and scope of the disclosure in its broadest form.

What is claimed is:

1. A system for management of facility space comprising:
an input component configured to receive occupancy data including space allocation by a plurality of facility space categories; and
a processor configured to determine an average utilization over a first period of time for each facility space category, identify at least one of an under utilization or an over utilization of the facility space over the first period of time, and generate a corrective action to shift space utilization of the facility space during a second period of time.

2. The system as described in claim 1, wherein the input component receives the occupancy data from a plurality presence sensors located in the facility space over the first period of time.

3. The system as described in claim 1, wherein the plurality of facility space categories include at least one of an open office area, a private office area, a conference area, or a focus booth area.

4. The system as described in claim 1, wherein the processor identifies at least one of an under utilization or an over utilization of a particular facility space category over the first period of time, and generates a corrective action to shift space utilization of the particular facility space from one facility space category to another facility space category during the second period of time.

5. The system as described in claim 1, wherein the processor identifies at least one of an under utilization or an over utilization of a particular sub-time period over the first period of time, and generates a corrective action to shift space utilization of the facility space from one sub-time period to another sub-time period during the second period of time.

6. The system as described in claim 1, wherein the corrective action includes at least one of communicating availability of the facility space during the second period of time or modifying access to the facility space during the second period of time.

7. The system as described in claim 1, further comprising an output component causing reallocation of the facility space at a remote device based on the corrective action.

8. A method for managing of facility space comprising:
receiving occupancy data by a management device, the occupancy data including space allocation by a plurality of facility space categories;
determining, by the management device, an average utilization over a first period of time for each facility space category;
identifying, by the management device, at least one of an under utilization or an over utilization of the facility space over the first period of time; and
generating, by the management device, a corrective action to shift space utilization of the facility space during a second period of time.

9. The method as described in claim 8, further comprising collecting the occupancy data from a plurality of presence sensors located in the facility space over the first period of time.

10. The method as described in claim 8, wherein the plurality of facility space categories include at least one of an open office area, a private office area, a conference area, or a focus booth area.

11. The method as described in claim 8, wherein:
identifying the at least one of an under utilization or an over utilization of the facility space over the first period of time includes identifying at least one of an under utilization or an over utilization of a particular facility space category over the first period of time; and
generating the corrective action to shift space utilization of the facility space during the second period of time includes generating a corrective action to shift space utilization of the particular facility space from one facility space category to another facility space category during the second period of time.

12. The method as described in claim 8, wherein:
identifying the at least one of an under utilization or an over utilization of the facility space over the first period of time includes identifying at least one of an under utilization or an over utilization of a particular sub-time period over the first period of time; and
generating the corrective action to shift space utilization of the facility space during the second period of time includes generating a corrective action to shift space utilization of the facility space from one sub-time period to another sub-time period during the second period of time.

13. The method as described in claim 8, wherein the corrective action includes at least one of communicating availability of the facility space during the second period of time or modifying access to the facility space during the second period of time.

14. The method as described in claim 8, further comprising causing reallocation of the facility space at a remote device based on the corrective action.

15. A non-transitory computer readable medium including executable instructions which, when executed, cause at least one processor to manage utilization of facility space by:
receive occupancy data by a management device, the occupancy data including space allocation by a plurality of facility space categories;
determine an average utilization over a first period of time for each facility space category;
identify at least one of an under utilization or an over utilization of the facility space over the first period of time; and
generate a corrective action to shift space utilization of the facility space during a second period of time.

16. The medium as described in claim 15, wherein executable instructions cause the at least one processor to further:
collect the occupancy data from a plurality of presence sensors located in the facility space over the first period of time; and
cause reallocation of the facility space at a remote device based on the corrective action.

17. The medium as described in claim 15, wherein the plurality of facility space categories include at least one of an open office area, a private office area, a conference area, or a focus booth area.

18. The medium as described in claim 15, wherein the executable instructions cause the at least one processor to:
identify the at least one of an under utilization or an over utilization of the facility space over the first period of time includes identifying at least one of an under utilization or an over utilization of a particular facility space category over the first period of time; and
generate the corrective action to shift space utilization of the facility space during the second period of time includes generating a corrective action to shift space utilization of the particular facility space from one facility space category to another facility space category during the second period of time.

19. The medium as described in claim 15, wherein the executable instructions cause the at least one processor to:
identify the at least one of an under utilization or an over utilization of the facility space over the first period of time includes identifying at least one of an under utilization or an over utilization of a particular sub-time period over the first period of time; and
generate the corrective action to shift space utilization of the facility space during the second period of time includes generating a corrective action to shift space utilization of the facility space from one sub-time period to another sub-time period during the second period of time.

20. The medium as described in claim 15, wherein the corrective action includes at least one of communicating availability of the facility space during the second period of time or modifying access to the facility space during the second period of time.
